(19) United States
(12) Patent Application Publication
(10) Pub. No.: US 2015/0371411 A1
(43) Pub. Date: Dec. 24, 2015

(54) COMPUTERIZED SYSTEMS AND METHODS FOR RENDERING A USER INTERFACE ELEMENT

(71) Applicant: Google Inc., Mountain View, CA (US)

(72) Inventors: John Nicholas JITKOFF, Kingsville, TX (US); Christopher Alan BANES, San Francisco, CA (US); Joshua James ESTELLE, San Francisco, CA (US)

(73) Assignee: Google Inc.

(21) Appl. No.: 14/748,651

(22) Filed: Jun. 24, 2015

Related U.S. Application Data
(60) Provisional application No. 62/016,612, filed on Jun. 24, 2014.

(51) Int. Cl. G06T 11/00; G06K 9/46; G06K 9/62; G06F 3/0481

(52) U.S. Cl. CPC G06T 11/001; G06F 3/04812; G06K 9/4652; G06K 9/6201

(57) ABSTRACT

Computer-implemented systems and methods are provided for rendering user interface elements. In accordance with some embodiments, a semantic name may be associated with an element of a user interface. Characteristics of an image associated with the user interface may be identified and compared with rules associated with the semantic name to identify a color. The element of the user interface may then be rendered in the identified color. Computer-implemented systems and methods are also provided for identifying a color for a user interface element. Characteristics of an image may be compared with each of a plurality of sets of rules associated with semantic names. A color that satisfies the set of rules may be identified for each of the sets of rules, and the identified colors may be presented to an operator.

### CROSS-REFERENCE TO RELATED APPLICATION(S)

This application claims the benefit of U.S. Provisional Patent Application No. 62/016,612, filed Jun. 24, 2014, the contents of which are hereby incorporated by reference in their entirety.

### BACKGROUND

The present disclosure relates to computerized systems and methods for rendering a user interface element and, more generally, the field of user interface design. By way of example, and without limitation, the present disclosure relates to computerized systems and methods for rendering an element of a user interface in a particular color based on characteristics of an image associated with the user interface.

The use of applications on electronic devices has grown significantly over the years. People now interact with applications on a variety of devices, such as personal computers, laptops, tablets, personal digital assistants (PDAs), personal organizers, mobile phones, smart-phones, and other devices. Developers of applications design interactive interfaces for the users of these applications to navigate through application content. With so many applications available today, developers have an incentive to make their applications attractive to users. One of the ways to do so is by making their application interfaces more aesthetically pleasing than those of other applications.

### SUMMARY

Embodiments of the present disclosure relate to computerized systems and methods for rendering user interface elements. In addition, embodiments of the present disclosure relate to solutions for presenting elements of a user interface in certain colors based on characteristics of images associated with the user interface.

In accordance with some embodiments of the present disclosure, computerized systems and methods are provided that identify characteristics of an image associated with a user interface. Once the characteristics are identified, they can be compared with one or more rules associated with a semantic name to identify a color that satisfies the rules. Once the color has been identified, an element of the user interface can be rendered in the identified color.

In accordance with some embodiments, there is provided a computer-implemented method for rendering a user interface element. The method comprises operations performed by one or more processors. The operations of the method include identifying characteristics of an image associated with a user interface, and identifying a semantic name associated with an element of the user interface. The method also includes comparing the identified characteristics with one or more rules associated with the semantic name to identify a color satisfying the one or more rules. The method further includes causing the element of the user interface to be rendered in the identified color when the color satisfies the rules.

Furthermore, in accordance with some embodiments, there is provided a computer-implemented system for rendering a user interface element. The system includes a memory device that stores instructions, and at least one processor that executes the instructions. The at least one processor executes the instructions to identify characteristics of an image associated with a user interface, and to identify a semantic name associated with an element of the user interface. The at least one processor also executes the instructions to compare the identified characteristics with one or more rules associated with the semantic name to identify a color satisfying the one or more rules. The at least one processor further executes the instructions to cause the element of the user interface to be rendered in the identified color when the color satisfies the rules.

Additionally, in accordance with some embodiments, there is provided a computer-implemented method for identifying a color for a user interface element. The method comprises operations performed by one or more processors. The operations of the method include identifying characteristics of an image associated with a user interface. The method also includes comparing the identified characteristics with each of a plurality of sets of one or more rules, each of the sets of rules being associated with a unique semantic name. The method further includes identifying, for each of the sets of rules, a color that satisfies the set of rules, and providing each identified color for presenting to an operator. The method still further includes receiving an indication of a request from the operator to associate one of the provided colors with a user interface element.

Still further, in accordance with some embodiments, there is provided a computer-implemented system for identifying a color for a user interface element. The system comprises a memory storing instructions, and at least one processor that executes the instructions. The at least one processor executes the instructions to identify characteristics of an image associated with a user interface. The at least one processor also executes the instructions to compare the identified characteristics with each of a plurality of sets of one or more rules, each of the sets of rules being associated with a unique semantic name. The at least one processor further executes the instructions to identify, for each of the sets of rules, a color that satisfies the set of rules, and to provide each identified color for presenting to an operator. The at least one processor still further executes the instructions to receive an indication of a request from the operator to associate one of the provided colors with a user interface element.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of this specification, and together with the description, illustrate and serve to explain the principles of various example embodiments.

FIG. 1 illustrates an example user interface screen including a rendering of a user interface element, consistent with embodiments of the present disclosure.

FIG. 2 illustrates a flowchart of an example method for rendering an element of a user interface, consistent with embodiments of the present disclosure.

FIG. 3A illustrates an example user interface screen including a rendering of a user interface element based on a first image, consistent with embodiments of the present disclosure.

FIG. 3B illustrates an example user interface screen including a rendering of a user interface element based on a second image, consistent with embodiments of the present disclosure.

FIG. 4 illustrates a flowchart of an example method for identifying a color for rendering a user interface element, consistent with embodiments of the present disclosure.

FIG. 5A illustrates an example user interface screen for extracting a palette of colors based on an image in a user interface, consistent with embodiments of the present disclosure.

FIG. 5B illustrates an example user interface screen for displaying a palette of colors based on an image in a user interface, consistent with embodiments of the present disclosure.

FIG. 6 illustrates a flowchart of an example method for identifying a color that satisfies rules associated with a semantic name, consistent with embodiments of the present disclosure.

FIG. 7 illustrates an example computer system for implementing embodiments and features consistent with the present disclosure.

FIG. 8 illustrates an example computing environment for implementing embodiments and features consistent with the present disclosure.

### DETAILED DESCRIPTION OF EXAMPLE EMBODIMENTS

Reference will now be made in detail to the present embodiments of the disclosure, certain examples of which are illustrated in the accompanying drawings.

Embodiments of the present disclosure relate to computerized systems and methods for rendering user interface elements. Embodiments of the present disclosure include systems and methods that identify characteristics of an image associated with a user interface. Once the characteristics are identified, they can be compared with one or more rules associated with a semantic name to identify a color satisfying the one or more rules. A user interface element may then be automatically rendered in the identified color. Alternatively an operator may confirm or select the color so that a user interface element is rendered in the selected color.

In some embodiments, a developer of an application or operator may associate a semantic name with an element of a user interface of the application. In some embodiments, the semantic name may be representative of characteristics of a color that the developer is interested in associating with the user interface element. For example, a term “dark” may be used in a semantic name to indicate a color with low luminance, and a term “light” may be used in a semantic name to indicate a color with high luminance. As another example, a term “vibrant” could be used in a semantic name to indicate a color with high saturation, and a term “muted” could be used in a semantic name to indicate a color with low saturation. Terms representative of color characteristics may also be combined in a semantic name. For example, a “dark vibrant” semantic name may indicate a color that is low in luminance, but high in saturation.

Once a semantic name is selected for association with a user interface element, characteristics of colors in an image associated with the user interface may be analyzed and compared with one or more rules associated with the semantic name to identify a color that is likely to be desired by the developer. For example, the one or more rules associated with a “vibrant” semantic name may result in the selection of a color from the image with a high saturation.

In some embodiments, once a semantic name is associated with a user interface element, different images can be placed in the user interface, and the element may be automatically rendered in a color related to the image based on the rules associated with the semantic name. The different images may be placed in the user interface during the development of the application, or may be placed in the user interface based on a selection by a user. For example, a user of a music application may download a new music album, and an album cover of the music album may be received and displayed in the user interface based on the download. When the user makes a selection that causes the album cover to be displayed, the user interface element (e.g., a play button) may be rendered in a color related to a color in the image.

In some embodiments, an operator may select to receive a plurality of colors (e.g., a palette of colors) related to colors in an image. Based on the operator's selection, characteristics of colors in the image may be identified and compared with each of a plurality of sets of one or more rules, where each of the sets of rules is associated with a unique semantic name. For each of the sets of rules, a color that satisfies the set of rules may be identified and presented to the developer in the palette of colors. The operator may then select to associate one of the associated colors with the user interface element, so that the user interface element is rendered in that the selected color.

One or more advantages may be achieved in rendering elements of a user interface in colors that match, or complement, colors in an image associated with the user interface. For example, if a screen of a user interface includes an image with lot of red pixels, it may be aesthetically pleasing to render an element in the screen in a shade of red. It may also be desirable to change the color in which the element is rendered. For example, if the user makes a selection that causes the user interface to switch to a screen displaying a different image containing a lot of blue pixels, it may be aesthetically pleasing to render the same element in that screen in a shade of blue.

Making a user interface more aesthetically pleasing to users may be advantageous to developers. With so many applications on the market today, users have a wide variety of options from which to choose. All else being equal, users may choose an application that is more aesthetically pleasing, and the popularity of the application may increase. Moreover, developers of popular applications that include advertising may command higher prices for advertising spots in their applications than developers of less popular applications. However, developing a user interface that provides elements of the user interface in visually appealing colors presents challenges to developers. For example, a developer of an application may have to identify a color that is appealing for a user interface element through a process of trial and error. Moreover, once a developer has found a color for a particular user interface element, the developer may have to identify a different color for the element in a different screen. Another challenge is that many applications allow end users to include new images in a user interface, such as a new image of a music album cover in a music application. Developers of such applications may not be able to identify colors that match, or complement, colors in such a new image, because they will not know the colors of the new image when developing the application.

Embodiments of the present disclosure can address the challenges associated with rendering user interface elements in visually appealing colors. For example, embodiments of the present disclosure provide computerized systems and methods that may render a user interface element in a screen of a user interface in a color based on characteristics of colors in an image in the screen. An operator, such as a developer of an application, may simply select a semantic name representative of certain color attributes that the user developer desires for the element (e.g., light, dark, muted, vibrant), and one or more rules associated with the semantic name may be associated with the element. Once the rules are associated with the element, the element may be rendered in a particular color in a screen of the user interface based on colors in an image of the screen and the rules.

Embodiments of the present disclosure may also be used to increase efficiency of users performing certain tasks. Using embodiments of the present disclosure, placeholders may be rendered in colors representative of images before the images are loaded. This may allow a user loading a photo library to quickly identify whether a particular set of loading images may be the images for which the user is looking. For example, if a user is searching for photos from a camping trip, placeholders displayed in greens and earth tone colors may indicate to the user that the images to be loaded may be the images for which the user is searching.

Embodiments of the present disclosure may also provide an operator or user with an easy way to view a plurality of colors (e.g., a palette of colors) related to colors identified in an image. The plurality of colors may be identified by comparing characteristics of colors in the image with each of a plurality of sets of one or more rules, where each of the sets of rules is associated with a unique semantic name. For example, for an image of the statue of liberty, a sky blue color may satisfy a set of one or more rules associated with a “light vibrant” semantic name. In the same example, a dark green color may be satisfy a set of one or more rules associated with a “dark vibrant” semantic name. The operator may then select one of the identified colors for association with a user interface element.

An element of a user interface, as used herein, may include any element of a user interface. Such an element may include, for example, a button, icon, toolbar, control, link, folder, list, scrollbar, menu, menu item, image, video, animation, text, background, window, control, hyperlink, drop-down list, slider, border, mouse, cursor, pointer, placeholder for loading content, or any other portion of a user interface.

An image, as used herein, may include any type of image, such as a picture, background image, or graphic. The image could have any format, such as Joint Photographic Experts Group (JPEG), JPEG File Interchange Format (JFIF), JPEG 2000, Exchangeable Image File Format (EXIF), Tagged Image File Format (TIFF), raw image format, Graphics Interchange Format (GIF), Windows bitmap (BMP), Portable Network Graphics (PNG), portable pixmap file (PPM), portable graymap file (PGM), portable bitmap file (PBM), WebP, or any other image file format.

As used herein, rendering a user interface element in a color may refer to utilizing the color in any way to render the user interface element. For example, the color may be utilized in a translucent overlay of the element, combined with an image as a colored overlay of the image, etc. Moreover, portions of a user interface element may be displayed in the color, while other portions of the user interface element may be displayed in a different color.

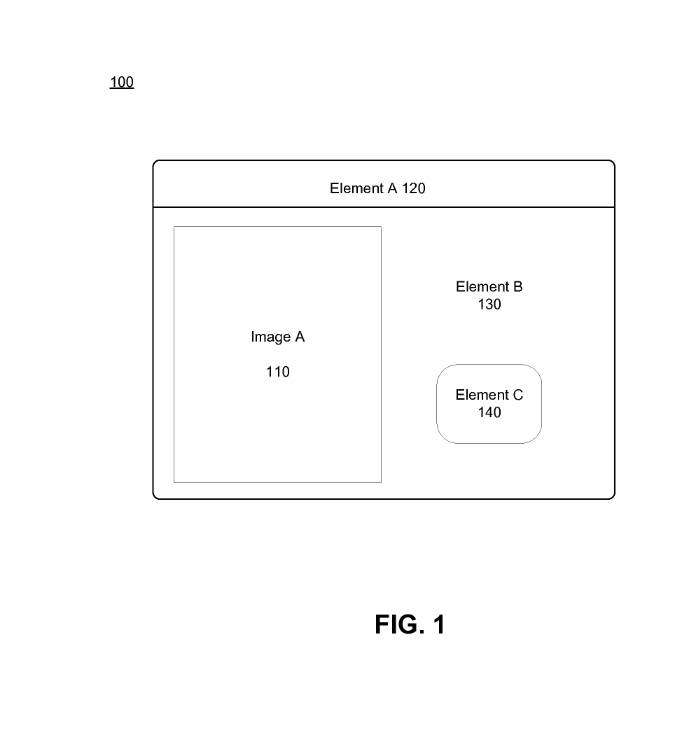

FIG. 1 illustrates an example screen 100 of a user interface of an application that may include an image A 110 and one or more user interface elements. In the example of FIG. 1, user interface element A 120 may be a toolbar, user interface element B 130 may be a background, and user interface element C 140 may be a button. Although three different user interface elements are illustrated in FIG. 1, the disclosure is not so limited. Any number of user interface elements may be included in a screen of user interface 100.

In accordance with embodiments of the disclosure, one or more of the user interface elements illustrated in FIG. 1 may be rendered in a color based on characteristics of colors identified in image A 110. For example, an operator may have associated a semantic name, such as “dark vibrant,” with any one or more of the user interface elements illustrated FIG. 1, such as element C 140. When this is the case, characteristics of colors in the image A 110 may be identified. This may occur, for example, when screen 100 is loading, or upon a user selection to load screen 100. Characteristics of the image may relate to one or more of a hue, intensity, radiance, luminance, luma, brightness, lightness, colorfulness, chroma, and saturation of colors in the image. The characteristics may then be compared with one or more rules associated with the semantic name “dark vibrant” to identify a color that satisfies the rules. For example, if the image is an image of the Statue of Liberty, the color may be a dark green color. Element C 140 may then be rendered in the dark green color. Rendering element C 140 in the dark green color may allow element C 140 to match, or complement, the colors in the image of the Statue of Liberty.

Similarly, one or more of element A 120 and element B 130 may be associated with a semantic name. For example, element A 120 may be associated with a semantic name, such as “light vibrant.” Based on the example where image A is an image of the Statue of Liberty, element A 120 may be rendered in a sky blue color based on identifying sky blue as a color that satisfies the rules associated with the “light vibrant” semantic name. As another example, element B 130 may be associated with a semantic name, such as “light muted.” Based on the example where image A is an image of the Statue of Liberty, element B 130 may be rendered in a light green color based on identifying light green as a color that satisfies the rules associated with the “light muted” semantic name. Thus, in some embodiments, a plurality of user interface elements may be associated with different semantic names and rendered in different colors, each of which match, or compliment, colors in an image.

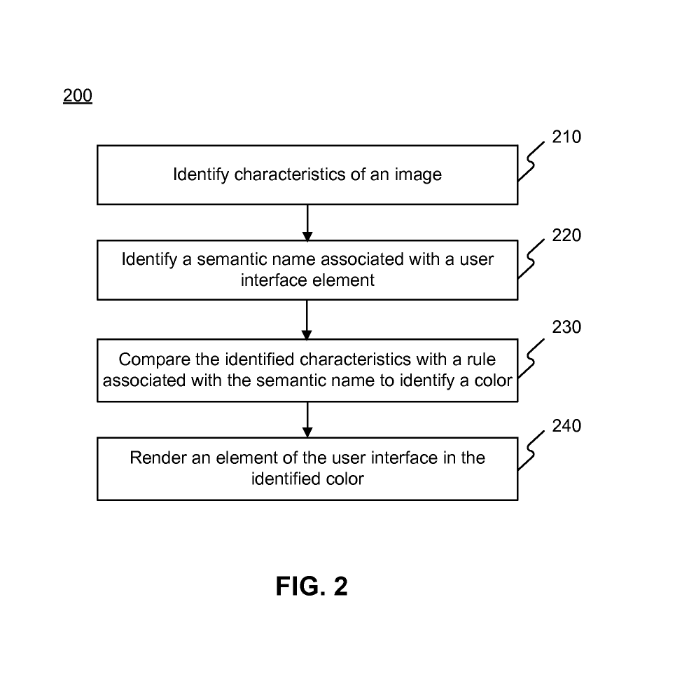

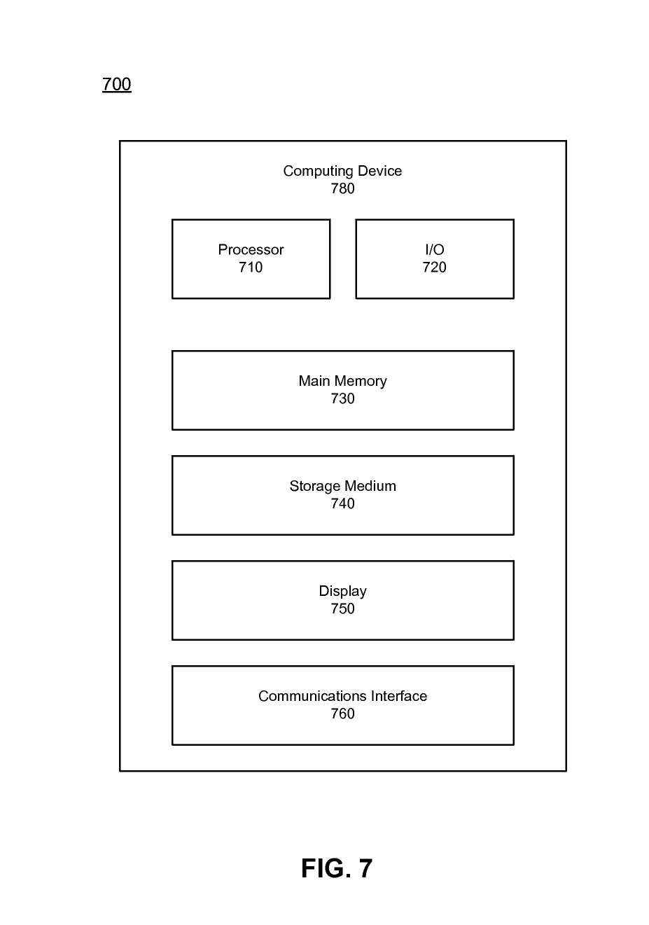

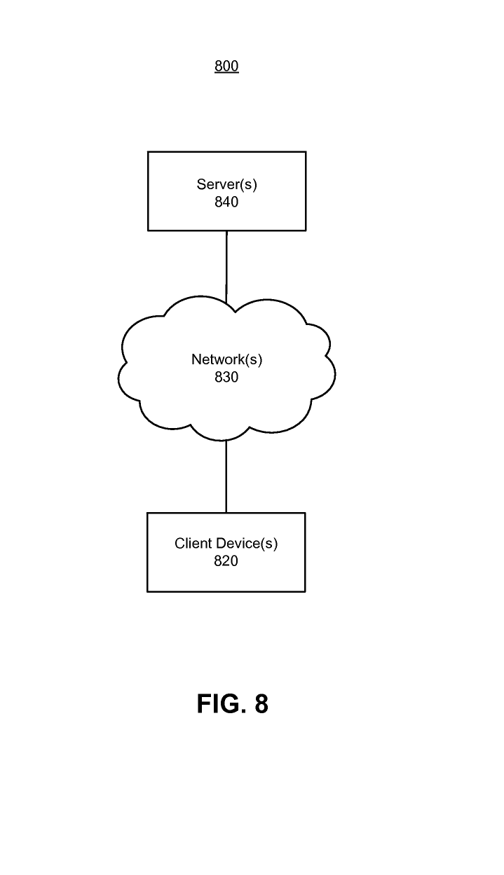

FIG. 2 illustrates a flowchart of an example method 200, consistent with embodiments of the present disclosure. Example method 200 may be implemented in a computing environment (see, e.g., FIG. 8) using one or more computer systems (see, e.g., FIG. 7). In some embodiments, method 200 may be performed by one or more client devices 820 or by one or more servers 840. In some embodiments, one or more steps of method 200 may be performed by one or more client devices 820, and one or more other steps of method 200 may be performed by one or more servers 840.

In step 210 of FIG. 2, characteristics of an image in a screen of a user interface may be identified. The characteristics of the image may include, for example, values related to one or more of a hue, intensity, radiance, luminance, luma, brightness, colorfulness, chroma, and saturation of the color in different pixels or regions of the image. In some embodiments, the characteristics of the image may include values of R, G, and B of a RGB color model for colors in different pixels, blocks, or regions of the image. Similarly, the characteristics of the image may include values of Y, Cb, and Cr of a YCbCr color model for colors, values of Y, Pb, and Pr of a YPbPr color model for colors, HSL values, HSV values, HSI values, or any other values that can be used to represent colors of pixels, blocks, or regions of the image. The identified characteristics of the image may also include a frequency with which a particular color appears in the image.

In some embodiments, the image may be analyzed to identify the characteristics of the image. One or more conventional image analysis techniques may be used to identify the characteristics of the image, such as content or comparative image analysis techniques. Alternatively, the characteristics of the image may be received as data associated with the image, such as metadata associated with the image. The data associated with the image may be received from a local drive of a computer, such as computer system(s) 700, or from a different computer, such as server(s) 840, over network(s) 830.

In step 220 of FIG. 2, a semantic name associated with an element of the user interface may be identified. For example, an operator, such as a developer, may have associated a semantic name with the element. The semantic name may be representative of attributes of colors in which the operator is interested in rendering the element. For example, a semantic name “dark” may be used to indicate that the operator is interested in colors with low luminance values, while a semantic name “light” may be used to indicate that the operator is interested in colors with high luminance values. Similarly, a semantic name “muted” may be used to indicate that the operator is interested in colors with low saturation values, and a semantic name “vibrant” may be used to indicate that the operator is interested in colors with high saturation values. A semantic name may combine terms to indicate a combination of color aspects in which the operator is interested. For example, “dark vibrant” may indicate that the operator is interested in colors that have low luminance values and high saturation values. The disclosure is not limited to the above examples of semantic names. Rather, any semantic name that is representative of types of colors may be used. Each of the semantic names may be associated with one or more rules for identifying colors that correspond to the semantic name.

In step 230, the identified characteristics of the image are compared with the one or more rules associated with the semantic name. For example, a “dark” semantic name may be associated with one or more rules establishing that only colors having luminance values below a particular threshold value may be returned as “dark” colors. Accordingly, luminance values of the identified characteristics may be compared with the rules to determine which of the colors in the image are “dark” colors. Similarly, a “light vibrant” semantic name may be associated with one or more rules establishing that only colors having luminance values above a particular threshold value and having saturation values above a particular threshold value may be returned as “light vibrant” colors. Accordingly, luminance values and saturation values of the identified characteristics may be compared with the rules to determine which of the colors in the image are “light vibrant” colors.

A “placeholder” semantic name may be associated with one or more rules configured to identify a color that is most representative of the image. This color may correspond to a color that appears most frequently in the image, or to a color in the image that has a high visual strength for humans. For a placeholder element in a user interface, metadata about an image that is loading may be received in advance of the image, and the placeholder element may be rendered in a color based on characteristics of the image identified from the metadata.

In step 240, the element of the user interface may be rendered in the color that is identified as satisfying the one or more rules associated with the semantic name. For example, if the semantic name associated with the element is “dark vibrant,” the user interface element may be rendered in a color from the image, or a color representative of a color in the image, that satisfies the one or more rules.

In some embodiments, a semantic name may be associated with a user interface element of a user interface of an application by an operator or developer of the application. Once the semantic name is associated with the user interface element, the operator or developer may place different images in user interface screens that include the element, and the element may be automatically rendered based on colors in the image and the associated semantic name. Moreover, the element may be automatically rendered based on colors in images that an end user may add to the application.

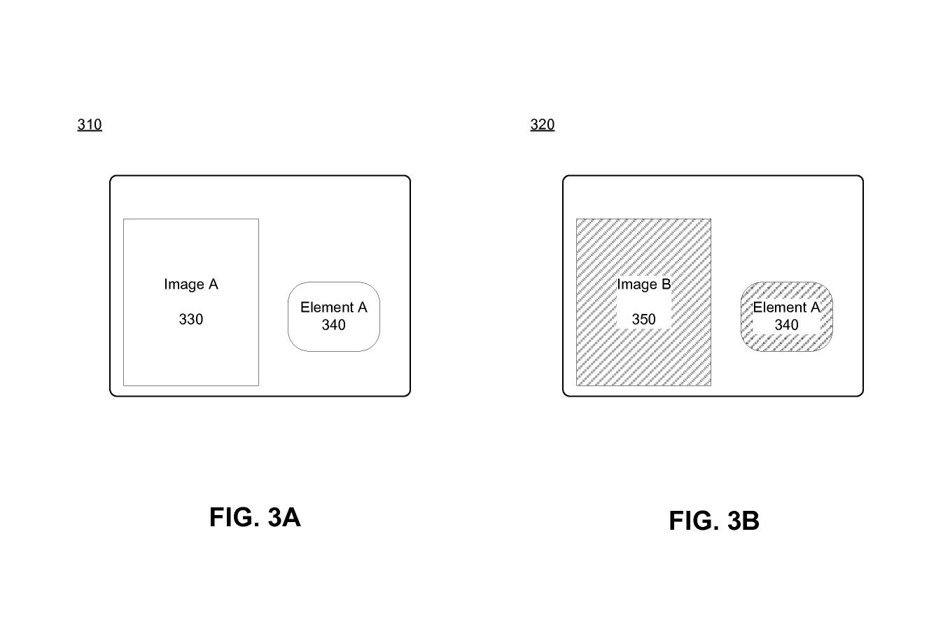

FIGS. 3A and 3B illustrate example screens 310 and 320 of a user interface of an application that may include a user interface element A 340, such as a button. In some embodiments, a computer, such as computer system(s) 700, may display screens 310 and/or 320 as a result of performing method 200 of FIG. 2. User interface screen 310 may include an image A 330, such as an image of the golden gate bridge, and user interface element A 340. Element A 340 may be associated with a semantic name, such as “dark vibrant.” As a result, element A 340 may be rendered in a dark red color based on the image of the golden gate bridge. In response to a user selection in the user interface, screen 320 of the user interface may be displayed. User interface screen 320 may include an image B 250, such as an image including a beach and an ocean, and the same user interface element 340 as in screen 310. Element 340 may still be associated with the “dark vibrant” semantic name; however, element 340 may be rendered in a dark blue color this time based on the new image of a beach and an ocean, image B 350.

The ability to automatically render user interface elements based on different images may be useful in applications where an end user is also adding new images to the user interface of the application. For example, if the application is a music player application, a user of the application may download a new music album. In such an example, an album cover may also be downloaded with the music album, and the album cover may be automatically displayed in a screen of the user interface when a user selects the album, along with a play button. Even though the album cover was not known to the developer of the application at the time the application was created, the user interface element (e.g., play button) may be rendered in a color that corresponds to its associated semantic name, and that matches, or complements the album cover.

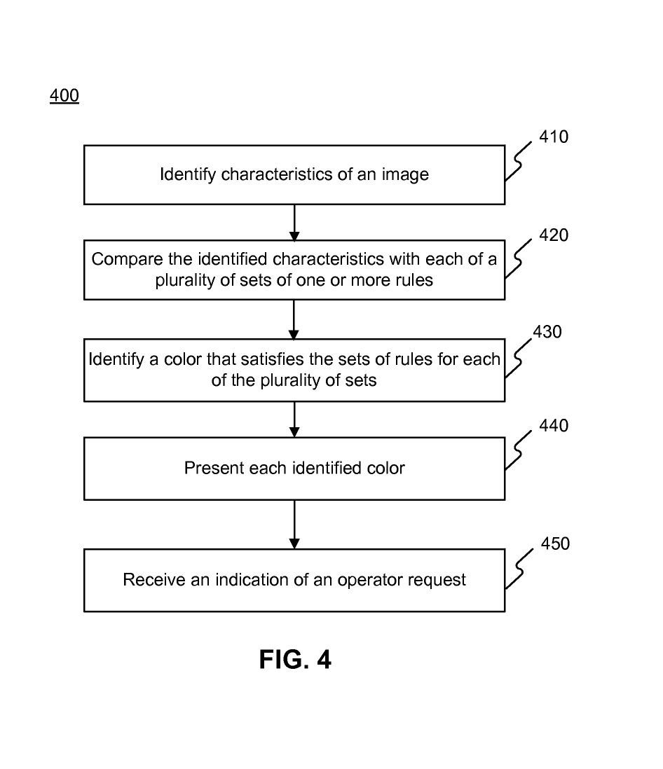

FIG. 4 illustrates a flowchart of another example method 400, consistent with embodiments of the present disclosure. Example method 400 may be implemented in a computing environment (see, e.g., FIG. 8) using one or more computer systems (see, e.g., FIG. 7). In some embodiments, method 400 may be performed by one or more client devices 820 or by one or more servers 840. In some embodiments, one or more steps of method 400 may be performed by one or more client devices 820, and one or more other steps of method 400 may be performed by one or more servers 840.

In step 410, characteristics of an image may be identified. As previously noted with respect to method 200, characteristics of an image may include, for example, values related to one or more of a hue, intensity, radiance, luminance, luma, brightness, colorfulness, chroma, and saturation of colors in different pixels or regions of the image. In some embodiments, the characteristics of the image may include values of R, G, and B of a RGB color model for colors in different pixels or regions of the image. Similarly, the characteristics of the image may include values of Y, Cb, and Cr of a YCbCr color model for colors, values of Y, Pb, and Pr of a YPbPr color model for colors, HSL values, HSV values, HSI values, or any other values that can be used to represent colors of pixels or regions of the image. The identified characteristics of the image may also include a frequency with which a particular color appears in the image.

In some embodiments, the image may be analyzed to identify the characteristics of the image. Conventional image analysis techniques may be used to identify the characteristics of the image, such as content or comparative image analysis techniques. Alternatively, the characteristics of the image may be received as data associated with the image, such as metadata associated with the image. The data associated with the image may be received from a local drive of a computer, such as computer system(s) 700, or over from a different computer, such as server(s) 840, over network(s) 830.

In step 420, the identified characteristics of the image may be compared with each of a plurality of sets of one or more rules, wherein each of the sets of rules may be associated with a unique semantic name. In some embodiments, a set of semantic names may be pre-stored as representative of a palette of different types of colors in which an operator, such as a developer, may be interested. For example, the semantic names may include one or more of “vibrant,” “muted,” “dark,” “light,” “dark vibrant,” “dark muted,” “light vibrant,” and “light muted.” A “placeholder” semantic name could also be included. It should be appreciated that the above semantic names are provided only as examples, and that any semantic names may be used. In some embodiments, the semantic names are representative of one or more aspects of a color in which the operator may be interested.

The identified characteristics of the image may be representative of colors in pixels or regions of the image, and compared with sets one or more rules, where each of the sets of rules is associated with a unique semantic name. For example, a “dark” semantic name may be associated with one or more rules establishing that only colors having luminance values below a particular threshold value may be returned as “dark” colors. Accordingly, luminance values of the identified characteristics may be compared with the rules to determine which of the colors in the image are “dark” colors. Similarly, a “light vibrant” semantic name may be associated with one or more rules establishing that only colors having luminance values above a particular threshold value and having saturation values above a particular threshold value may be returned as “light vibrant” colors. Accordingly, luminance values and saturation values of the identified characteristics may be compared with the rules to determine which of the colors in the image are “light vibrant” colors.

A “placeholder” semantic name may be associated with one or more rules configured to identify a color that is most representative of the image. This color may correspond to a color that appears most frequently in the image, or to a color in the image that has a high visual strength for humans. For a placeholder element in a user interface, metadata about an image that is loading may be received in advance of the image, and the placeholder element may be rendered in a color based on characteristics of the image identified from the metadata.

In step 430, a color may be identified that satisfies the sets of rules for each of the plurality of sets of rules associated with the semantic names. For example, if the image is an image of the statue of liberty, a light green color may be identified for a “light muted” semantic name, a dark green color may be identified for a “dark vibrant” semantic name, a sky blue color may be identified for a “light vibrant” semantic name, etc. In some embodiments, colors may be identified for each of the semantic names in the plurality of semantic names. In some other embodiments, colors may be identified for only some of the semantic names in the plurality of semantic names.

In step 440, the identified colors may be presented to the operator or other user. In some embodiments, the identified colors may be presented as a palette of colors. In some embodiments, each of the identified colors may be presented in associated with its associated semantic name.

In step 450, an indication of a selection of an operator or user may be received. In some embodiments, the indication may indicate that the operator selected a color to associate with a user interface element. In some embodiments, the indication may indicate that the operator selected a semantic name to associate with a user interface element. For example, the operator may select to associate the “placeholder” semantic name with a space of a user interface that is a placeholder for loading content, such as an image. By doing so, the placeholder space of the user interface may be rendered in a color representative of the image before the image is loaded. This may be more visually appealing to end users than viewing a blank space while the image is loading.

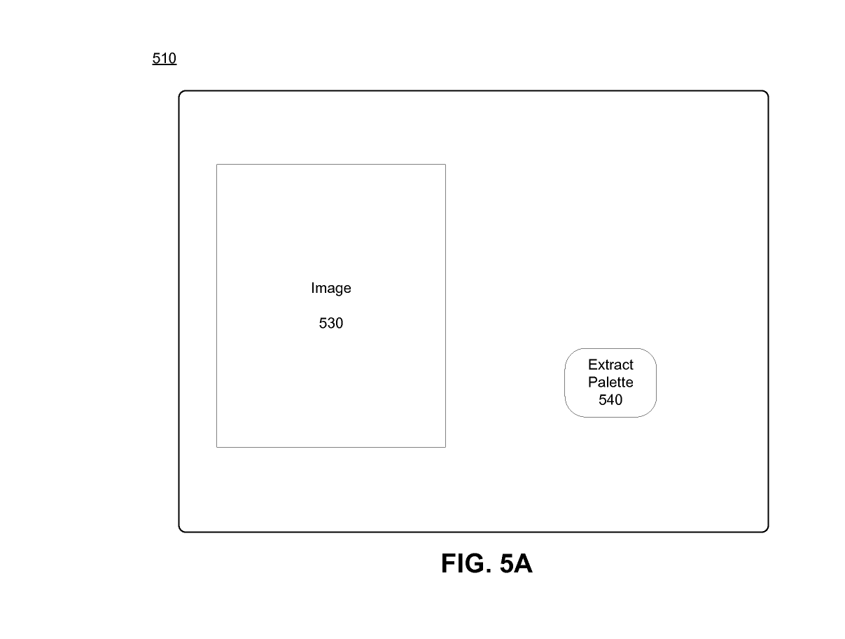

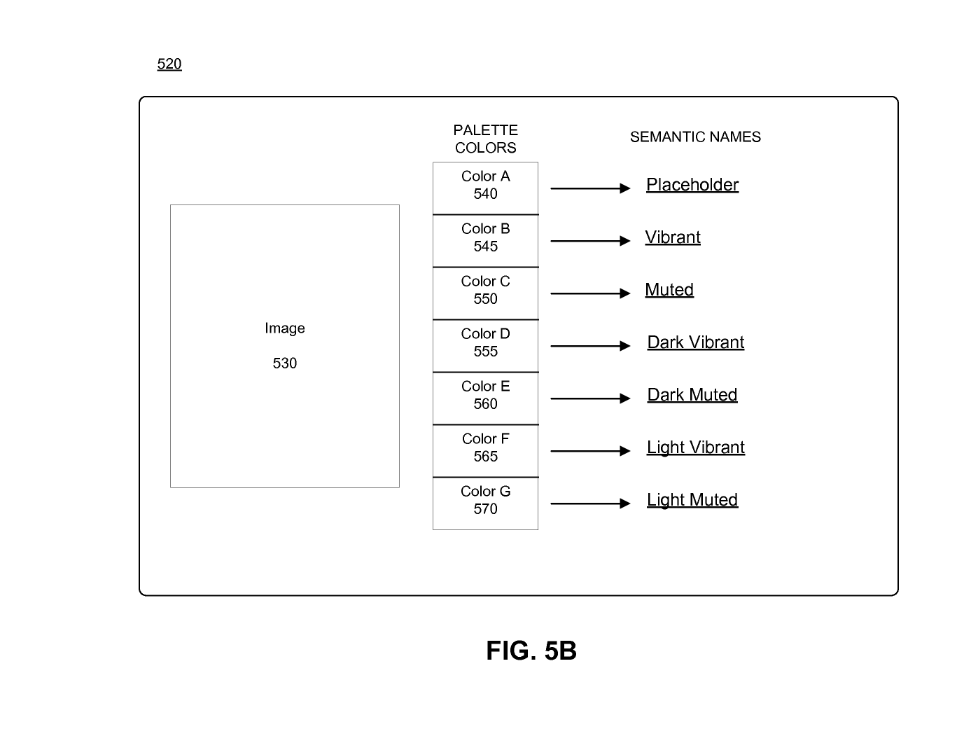

FIGS. 5A and 5B illustrate example screens 510 and 520 of a user interface of an application that may include an image 530. In some embodiments, a computer, such as computer system(s) 700, may display screens 510 and/or 520 as a result of performing method 400 of FIG. 4. User interface screen 510 of FIG. 5A may include an image 530 and a control element 540. An operator or application developer may select control element 540 to extract a palette of colors associated with certain pre-stored semantic names. Control element 540 may be any type of selectable user interface element. In response to a selection of control element 540, a screen, such as screen 520 of FIG. 5B, may be provided.

Screen 520 of FIG. 5B illustrates a palette of colors extracted for each of a plurality of semantic names based on colors in image 530. For example, color A 540 may represent a “placeholder” color, color B 545 may represent a “vibrant” color, color C 550 may represent a “muted” color, color D 555 may represent a “dark vibrant” color, color E 560 may represent a “dark muted” color, color F 565 may represent a “light vibrant” color, and color G 570 may represent a “light muted” color. In some embodiments, the identified colors may be provided with their corresponding semantic names, as illustrated in screen 520 of FIG. 5B. While seven colors and seven semantic names are illustrated in screen 520 of FIG. 5B, the disclosure is not so limited. Any number of colors and/or semantic names may be presented.

In some embodiments, a color from the palette of colors may be selected for associating with one or more elements of a user interface. For example, an operator or application developer may select a color from the palette of colors for associating with one or more elements of a user interface of an application. In some embodiments, the operator or developer may select a semantic name from the list of semantic names to associate the semantic name with one or more elements of a user interface.

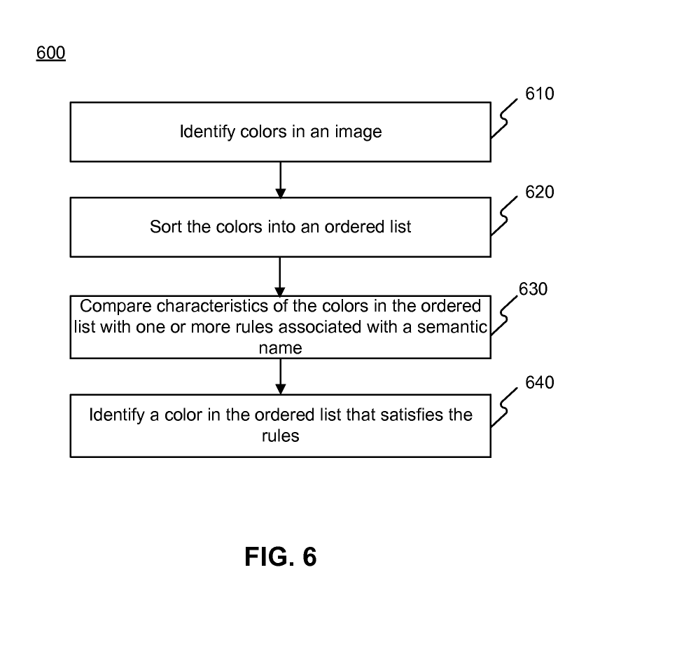

FIG. 6 illustrates a flowchart of an example method 600 for identifying characteristics of an image, comparing the identified characteristics with one or more rules associated with a semantic name, and identifying a color that satisfies the rules. Example method 600 may be implemented in a computing environment (see, e.g., FIG. 8) using one or more computer systems (see, e.g., FIG. 7). In some embodiments, method 600 may be performed by one or more client devices 820 or by one or more servers 840. In some embodiments, one or more steps of method 600 may be performed by one or more client devices 820, and one or more other steps of method 600 may be performed by one or more servers 840. In some embodiments, steps 210 and 230 of method 200 of FIG. 2, and/or steps 410-430 of method 400 of FIG. 4, may be implemented using method 600 of FIG. 6.

In step 610, colors may be identified in an image. In some embodiments, colors in each pixel, block, or region of the image may be identified. In some embodiments, each of the identified colors may be stored in a map, list, or table in association with the pixel, block, or region of the image in which it was identified. In some embodiments, the colors may be stored as characteristics of the colors. For example, colors may be represented in values of hue, intensity, radiance, luminance, luma, brightness, colorfulness, chroma, and/or saturation. In some embodiments, colors may be represented as a combination of values corresponding to a color model, such as values of R, G, and B of a RGB color model, values of Y, Cb, and Cr of a YCbCr color model, values of Y, Pb, and Pr of a YPbPr color model, HSL values, HSV values, HSI values, or any other values of any other color models.

In some embodiments, the image may include a large number of different colors. To reduce the number of colors that need to be handled, method 600 may force the colors to a certain limited number of colors. For example, a color blue that is a slightly lighter shade than another color of blue in the image may be treated as the same color blue. Method 600 may use a known image analysis technique, such as adaptive quantization, to limit the number of colors in the image to a certain number of colors (e.g., 12-16 colors). Method 600 may then count the number of pixels, blocks, or regions of the image in which a particular color appears, and, in step 620, may store the colors in a an ordered list with the colors sorted from those appearing most frequently in the image to those appearing least frequently in the image.

In step 630, the color appearing most frequently in the ordered list may be compared with one or more rules associated with a semantic name. For example, the semantic name may be a semantic name associated with a user interface element, such as in the example of method 200 of FIG. 2. As another example, the semantic name may be one of a plurality of semantic names of a palette of colors to extract from an image, such as in the example of method 400 of FIG. 4. The one or more rules may identify one or more values for hue, intensity, radiance, luminance, luma, brightness, colorfulness, chroma, saturation, R, G, and B of a RGB color model, Y, Cb, and Cr of a YCbCr color model, Y, Pb, and Pr of a YPbPr color model, HSL, HSV, and/or HSI that must satisfied in order to qualify as a color for the semantic name. For example, the rules may establish that values must be greater than, less than, equal to or greater than, or equal to or less than a particular value in order to qualify as a color for the semantic name.

In one example, values of R, G, and B of a color may be compared with one or more rules to determine whether a color qualifies as a color for the semantic name. For example, a bright orange color with an R value of 217, a G value of 118, and a B value of 33 may satisfy one or more rules for “dark vibrant” color. In a further example, values for hue, intensity, radiance, luminance, luma, brightness, colorfulness, chroma, saturation, R, G, and B of a RGB color model, Y, Cb, and Cr of a YCbCr color model, Y, Pb, Pr of a YPbPr color model, HSL, HSV, and/or HSI may be converted to a different color model before performing the comparison. For example, RGB values may be converted to HSL values and compared with one or more rules for HSL values associated with a semantic name.

If the most frequently appearing color does not satisfy the one or more rules associated with the semantic name, method 600 may compare the second most frequently occurring color (e.g., the next one down the ordered list) with the one or more rules to determine whether the second most frequently occurring color satisfies the rules. Method 600 may continue in this fashion until a color is identified that satisfies the one or more rules associated with the semantic name.

It should be appreciated that the above method is merely one example of how characteristics may be identified and compared with one or more rules associated with a semantic name to identify a color that satisfies the rules. Any other method could be used for identifying the color, and any other characteristics of an image could be compared with any other rules for identifying the color. In some embodiments, a frequency with which a color appears in an image may be only one factor used in sorting the ordered list. For example, a combination of factors could be used in sorting the ordered list.

In some embodiments, another factor that could be used in sorting the ordered list are values related to a visual strength of the colors. For example, some colors have a greater visual strength to humans than others. Such a color may appear to a human as being more dominant in an image even if the number of pixels of that color is relatively small compared to those of another color. An example of such a color may be a bright red color. In some embodiments, visual strength values may be associated with each of the colors, and the colors may be sorted in the ordered list based on a weighted combination of a visual strength of the colors and the frequency with which the colors appear in the image. In some embodiments, certain colors may be weighted less than other colors, so that they appear lower in the ordered list than the frequency of the colors appearance in the image would otherwise place them. For example, colors resembling human skin tone may be considered to be undesirable for user interface elements, and may be weighted so as to be placed toward the bottom of the ordered list, or removed from the ordered list entirely.

In some embodiments, none of the colors may satisfy the rules associated with a particular semantic name. For example, if an operator has specified a “dark vibrant” semantic name for a particular user interface element, it is possible that none of the colors in the image satisfy the rules associated with the “dark vibrant” semantic name. In such a scenario, a color could be identified based on a different color identified in the ordered list. For example, a “vibrant” color (e.g., sky blue) could be identified in the ordered list, and a “dark vibrant” color (e.g., ocean blue) could be calculated based off of the “vibrant” color.

Although the above example may relate to identifying a color that satisfies the one or more rules associated with a semantic name, method 600 may be used to identify colors that satisfy sets of rules for each of a plurality of sets of rules, where each of the sets of rules corresponds to a semantic name. For example, a color appearing at the top of the ordered list may be compared with each of the sets of rules to determine whether the color satisfies any of the sets of rules. In so doing, method 600 may traverse the ordered list and identify a color that satisfies the sets of rules for each of a plurality of sets of rules associated with semantic names.

As indicated throughout this disclosure, semantic names representative of aspects of colors may be associated with elements of a user interface, so that the elements are rendered in particular colors based on images associated with the user interface. Once a semantic name has been associated with an element of the user interface, rules may be defined or provided for rendering other elements of the user interface based on the semantic name associated with the element. For example, a button element may be overlaid with a text element. One or more rules may be associated with the text element to render the text in a color that contrasts with the semantic name of the button element. For example, if a button is associated with a “dark vibrant” semantic name, and a text element overlays the button, the text element may be rendered in a light color based on one or more rules associated with the text element that cause the text element to be rendered in a color in contrast to the button. These types of rules may be referred to as related color rules, and may include rules for rendering elements in colors that contrast, or complement, other elements in the user interface.

FIG. 7 is a block diagram illustrating an example computer system 700 that may be used for implementing embodiments consistent with the present disclosure, including the example systems and methods described herein. Computer system 700 may include one or more computing devices 780. Computer system 700 may be used to implement client device(s) 820, and/or server(s) 840, of computing environment 800 of FIG. 8. The arrangement and number of components in computer system 700 is provided for purposes of illustration. Additional arrangements, number of components, or other modifications may be made, consistent with the present disclosure.

As shown in FIG. 7, a computing device 780 may include one or more processors 710 for executing instructions. Processors suitable for the execution of instructions include, by way of example, both general and special purpose microprocessors, and any one or more processors of any kind of digital computer. A computing device 780 may also include one or more input/output (I/O) devices 720. By way of example, I/O devices 720 may include keys, buttons, mice, joysticks, styluses, gesture sensors (e.g., video cameras), motion sensors (e.g., infrared sensors, ultrasound sensors, etc.), voice sensors (e.g., microphones), etc. Keys and/or buttons may be physical and/or virtual (e.g., provided on a touch screen interface).

A computing device 780 may include one or more storage devices configured to store data and/or software instructions used by processor(s) 710 to perform operations consistent with disclosed embodiments. For example, a computing device 780 may include main memory 730 configured to store one or more software programs that, when executed by processor(s) 710, cause processor(s) 710 to perform functions or operations consistent with disclosed embodiments. In some embodiments, software instructions for performing operations consistent with disclosed embodiments may be provided in an application programming interface (API) that is made available to developers of applications. For example, the software instructions may be included as part of an API available to developers of applications for certain computing platforms. The API may be downloaded by a developer, and instructions in the API may be executed by processor(s) 710 to perform functions or operations consistent with disclosed embodiments.

By way of example, main memory 730 may include NOR or NAND flash memory devices, read only memory (ROM) devices, random access memory (RAM) devices, etc. A computing device 780 may also include on or more storage mediums 740. By way of example, storage medium(s) 740 may include hard drives, solid state drives, tape drives, redundant array of independent disks (RAID) arrays, etc. Although FIG. 7 illustrates only one main memory 730 and one storage medium 740, a computing device 780 may include any number of main memories 730 and storage mediums 740. Further, although FIG. 7 illustrates main memory 730 and storage medium 740 as part of computing device 780, main memory 730 and/or storage medium 740 may be located remotely and computing device 780 may be able to access main memory 730 and/or storage medium 740 via network(s), such as network(s) 830 of computing environment 800 of FIG. 8.

Storage medium(s) 740 may be configured to store data, and may store data received from one or more of server(s) 840 or client device(s) 820. The data may take or represent various content or information forms, such as content, metadata, documents, textual content, image files, video files, markup information (e.g., hypertext markup language (HTML) information, extensible markup language (XML) information), software applications, instructions, and/or any other type of information that may be with a user interface of an application.

A computing device 780 may also include one or more displays 750 for user interfaces, displaying data, and information. Display(s) 750 may be implemented using one or more display panels, which may include, for example, one or more cathode ray tube (CRT) displays, liquid crystal displays (LCDs), plasma displays, light emitting diode (LED) displays, touch screen type displays, projector displays (e.g., images projected on a screen or surface, holographic images, etc.), organic light emitting diode (OLED) displays, field emission displays (FEDs), active matrix displays, vacuum fluorescent (VFR) displays, 3-dimensional displays, electronic paper (e-ink) displays, microdisplays, or any combination of the above types of displays.

A computing device 780 may further include one or more communications interfaces 760. Communication interface(s) 760 may allow software and/or data to be transferred between server(s) 840 and client device(s) 820. Examples of communications interface(s) 760 may include modems, network interface cards (e.g., Ethernet card), communications ports, personal computer memory card international association (PCMCIA) slots and cards, antennas, etc. Communication interface(s) 760 may transfer software and/or data in the form of signals, which may be electronic, electromagnetic, optical, and/or other types of signals. The signals may be provided to/from communications interface(s) 760 via a communications path (e.g., network(s) 830), which may be implemented using wired, wireless, cable, fiber optic, radio frequency (RF), and/or other communications channels.

The disclosed embodiments are not limited to separate programs or computers configured to perform dedicated tasks. For example, a server 840 may include a main memory 730 that stores a single program or multiple programs and may additionally execute one or more programs located remotely from server 840. Similarly, a client device 820 may execute one or more remotely stored programs instead of, or in addition to, programs stored on client device 820. In some example embodiments, a server 840 may be capable of accessing separate server(s) and/or computing devices that generate, maintain, and provide web sites.

FIG. 8 illustrates a block diagram of an example computing environment 800 for implementing embodiments and features of the present disclosure. The arrangement and number of components in environment 800 is provided for purposes of illustration. Additional arrangements, number of components, and other modifications may be made, consistent with the present disclosure.

As shown in FIG. 8, computing environment 800 may include one or more client devices 820. By way of example, a client device 820 could be a mobile phone, smart phone, tablet, netbook, electronic reader, personal digital assistant (PDA), personal computer, laptop computer, smart watch, gaming device, desktop computer, set-top box, television, personal organizer, portable electronic device, smart appliance, navigation device, and/or other types of computing devices. In some embodiments, a client device 820 may be implemented with hardware devices and/or software applications running thereon. A user may use a client device 820 to communicate with server(s) 840 over network(s) 830. A client device 820 may communicate by transmitting data to and/or receiving data from server(s) 840. In some embodiments, one or more of client device(s) 820 may be implemented using a computer system, such as computer system 700 of FIG. 7.

Computing environment 800 may also include one or more server(s) 840. By way of example, server(s) 840 could include any combination of one or more of web servers, databases, mainframe computers, general-purpose computers, personal computers, or other types of computing devices. In some embodiments, one or more of server(s) 840 may be configured to host a web page, implement a search engine, index information, store information, and/or retrieve information. In some embodiments, a server 840 may be a standalone computing system or apparatus, or it may be part of a larger system. For example, server(s) 840 may represent distributed servers that are remotely located and communicate over a communications network, or over a dedicated network, such as a local area network (LAN). Server(s) 840 may include one or more back-end servers for carrying out one or more aspects of the present disclosure.

Server(s) 840 may be implemented as a server system comprising a plurality of servers, or a server farm comprising a load balancing system and a plurality of servers. In some embodiments, a server 840 may be implemented with hardware devices and/or software applications running thereon. A server 840 may communicate with client device(s) 820 over network(s) 830. For example, a server 840 may communicate by transmitting data to and/or receiving data from client device(s) 820. In some embodiments, one or more of server(s) 840 may be implemented using a computer system, such as computer system 700 of FIG. 7.

In some embodiments, server(s) 840 may store image files and/or metadata associated with image files. User interfaces of applications running on client device(s) 820 may download the image files and/or metadata, and may identify characteristics of the images in the image files by analyzing the image files or the metadata. In some embodiments, server(s) 840 may identify characteristics of images stored at server(s) 840, may compare the identified characteristics with sets of rules associated with semantic names, and/or may identify colors from images that correspond to semantic names, and may store this information as metadata at server(s) 840. By doing so, a client device 820 may simply download the metadata to identify a color from the image that corresponds to the semantic name. That is, the processing of the image data and its comparison with the rules will be performed by server(s) 840, so that client device(s) 820 do not have to perform these steps themselves. Moreover, themes for associating semantic names with various user interface elements may be stored at server(s) 840, and may be downloaded and applied to applications by developers, so that they do not have decide which semantic names to associate with elements of a user interface.

Computing environment 800 may still further include one or more networks 830. Network(s) 830 may connect server(s) 840 with client device(s) 820. network(s) 830 may provide for the exchange of information, such as queries for information and results, between client device(s) 820 and server(s) 840. Network(s) 830 may include one or more types of networks interconnecting client device(s) 820 and server(s) 840.

Network(s) 830 may include one or more wide area networks (WANs), metropolitan area networks (MANs), local area networks (LANs), personal area networks (PANs), or any combination of these networks. Network(s) 830 may include one network type, or a combination of a variety of different network types, including Internet, intranet, Ethernet, twisted-pair, coaxial cable, fiber optic, cellular, satellite, IEEE 802.11, terrestrial, Bluetooth, infrared, wireless universal serial bus (wireless USB), and/or other types of wired or wireless networks.

It should be appreciated that there are a variety of uses for the embodiments and techniques disclosed herein. For example, in addition to the uses previously described, the embodiments and techniques disclosed herein may be used to render colors in placeholder spaces of a user interface while waiting for content, such as an image, to load. The embodiments and techniques disclosed herein may also be used to set neighboring color fields in a user interface. The embodiments and techniques disclosed herein may further be used to create image fade in or fade out effects. The embodiments and techniques disclosed herein may still further be used to render duotone images. The embodiments and techniques disclosed herein may also be used to render different colors for different types of loading content, to indicate the type of content about to load.

While illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including reordering steps and/or inserting or deleting steps.

The many features and advantages of the disclosure are apparent from the detailed specification, and thus, it is intended that the appended claims cover all systems and methods, which fall within the true spirit and scope of the disclosure. As used herein, the indefinite articles “a” and “an” mean “one or more” in open-ended claims containing the transitional phrase “comprising,” “including,” and/or “having.” Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed:

1. A computer-implemented method for rendering a user interface element, the method comprising the following operations performed by one or more processors:
identifying characteristics of an image associated with a user interface;
identifying a semantic name associated with an element of the user interface;
comparing the identified characteristics with one or more rules associated with the semantic name to identify a color satisfying the one or more rules; and
causing the element of the user interface to be rendered in the identified color when the color satisfies the one or more rules.

2. The computer-implemented method of claim 1, wherein the image is a first image, the characteristics are first characteristics, and the color is a first color, and further wherein the method comprises the following additional operations performed by the one or more processors:
identifying second characteristics of a second image associated with the user interface;
comparing the identified second characteristics with the one or more rules associated with the semantic name to identify a second color satisfying the one or more rules; and
rendering the element of the user interface in the identified second color when the second color satisfies the one or more rules.

3. The computer-implemented method of claim 1, wherein the semantic name is associated with the element of the user interface based upon a user selection.

4. The computer-implemented method of claim 1, wherein the element of the user interface is a first user interface element and the color is a first color, and further comprising:
rendering a second user interface element in a second color that is determined based on the semantic name associated with the first user interface element, wherein the second color is selected so as to contrast or complement a type of color represented by the semantic name, and wherein the type of color is one of a dark or light color.

5. The computer-implemented method of claim 1, wherein the element of the user interface is one of a button, icon, toolbar, scrollbar, background, picture, video, animation, or portion of a screen of the user interface.

6. The computer-implemented method of claim 1, further comprising:
analyzing the image to identify colors in the image;
receiving metadata associated with the image; and
identifying the characteristics of the image based on the identified colors and the metadata.

7. A computer-implemented system for rendering a user interface element, comprising:
a memory device that stores instructions; and
at least one processor that executes the instructions to perform operations that:
identify characteristics of an image associated with a user interface;
identify a semantic name associated with an element of the user interface;
compare the identified characteristics with one or more rules associated with the semantic name to identify a color satisfying the one or more rules; and
cause the element of the user interface to be rendered in the identified color when the color satisfies the one or more rules.

8. The system of claim 7, wherein the image is a first image, the characteristics are first characteristics, and the color is a first color, and wherein the operations:
identify second characteristics of a second image associated with the user interface;
compare the identified second characteristics with the one or more rules associated with the semantic name to identify a second color satisfying the one or more rules; and
render the element of the user interface in the identified second color when the second color satisfies the one or more rules.

9. The system of claim 7, wherein the semantic name is associated with the element of the user interface based upon a user selection.

10. The system of claim 7, wherein the element of the user interface is a first user interface element and the color is a first color, and wherein the operations:
render a second user interface element in a second color that is determined based on the semantic name associated with the first user interface element, wherein the second color is selected so as to contrast or complement a type of color represented by the semantic name, and wherein the type of color is one of a dark or light color.

11. The system of claim 7, wherein the element of the user interface is one of a button, icon, toolbar, scrollbar, background, picture, video, animation, or portion of a screen of the user interface.

12. The system of claim 7, wherein the operations:
analyze the image to identify colors in the image;
receive metadata associated with the image; and
identify the characteristics of the image based on the identified colors and the metadata.

13. A computer-implemented method for identifying a color for a user interface element, comprising the following operations performed by one or more processors:
identifying characteristics of an image associated with a user interface;
comparing the identified characteristics with each of a plurality of sets of one or more rules, each of the sets of one or more rules being associated with a unique semantic name;
identifying, for each of the sets of one or more rules, a color that satisfies the set of one or more rules;
providing each identified color for presenting to an operator; and
receiving an indication of a request from the operator to associate one of the provided colors with a user interface element.

14. The computer-implemented method of claim 13, wherein the user interface element is one of a button, icon, toolbar, scrollbar, background, picture, video, animation, or portion of a screen of the user interface.

15. The computer-implemented method of claim 13, further comprising:
analyzing the image to identify colors in the image;
receiving metadata associated with the image; and
identifying the characteristics of the image based on the identified colors and the metadata.

16. The computer-implemented method of claim 13, wherein:
the identified characteristics relate to at least one of a hue, intensity, radiance, luminance, luma, brightness, lightness, colorfulness, chroma, and saturation of a color in the image; and
one of the plurality of sets of one or more rules defines a criteria that one or more of the identified characteristics of a color in the image must meet in order to be correlated with the semantic name associated with the set of one or more rules, and wherein the criteria includes at least one of a luminance or saturation value that must be exceeded.

17. The computer-implemented method of claim 13, wherein the user interface element is rendered in the associated color based on the received indication.

18. The computer-implemented method of claim 13, wherein each identified color is presented to the user along with a semantic name associated with the set of one or more rules each color satisfied.

19. A computer-implemented system for identifying a color for a user interface element, comprising:
a memory storing instructions; and
at least one processor that executes the instructions to perform operations that:
identify characteristics of an image associated with a user interface;
compare the identified characteristics with each of a plurality of sets of one or more rules, each of the sets of one or more rules being associated with a unique semantic name;
identify, for each of the sets of one or more rules, a color that satisfies the set of one or more rules;
present each identified color for display to an operator; and
receive an indication of a request from the operator to associate one of the provided colors with a user interface element.

20. The system of claim 19, wherein the user interface element is one of a button, icon, toolbar, scrollbar, background, picture, video, animation, or portion of a screen of the user interface.

21. The system of claim 19, wherein the operations further:
analyze the image to identify colors in the image;
receive metadata associated with the image; and
identify the characteristics of the image based on the identified colors and the metadata.

22. The system of claim 19, wherein:
the identified characteristics relate to at least one of a hue, intensity, radiance, luminance, luma, brightness, lightness, colorfulness, chroma, and saturation of a color in the image; and
one of the plurality of sets of one or more rules defines a criteria that one or more of the identified characteristics of a color in the image must meet in order to be correlated with the semantic name associated with the set of one or more rules, and wherein the criteria includes at least one of a luminance or saturation value that must be exceeded.

23. The system of claim 19, wherein the user interface element is rendered in the associated color based on the received indication.

24. The system of claim 19, wherein each identified color is presented to the user along with a semantic name associated with the set of one or more rules each color satisfied.
